(19) United States
(12) Patent Application Publication
(10) Pub. No.: US 2008/0208698 A1
(43) Pub. Date: Aug. 28, 2008

(54) Point of sale video server processing system

(76) Inventors: Quentin Olson, Poulsbo, WA (US); Wayne Baratta, Poughkeepsie, NY (US)

Correspondence Address: George O Saile and Assocs, 28 Davis Ave, Poughkeepsie, NY, 12603, US

(21) Appl. No.: 11/710,723

(22) Filed: Feb. 26, 2007

(51) Int. Cl. G06Q 20/00

(52) U.S. Cl. 705/21

(57) ABSTRACT

This invention provides a system and a method for low cost video surveillance and archiving which is synchronized with point of sale (POS) transactions. There is no local storage of video at the POS. There is high speed transmission of the video out of the stores to central servers. All back office applications are browser based. The system provides for inherent video compression due to hardware and software involved with the video capture. Management can watch present or past store activity anywhere anytime via web browsers. Video records are indexed and retrieved from server memory along with corresponding transaction information.

### RELATED PATENT APPLICATION

This application is related to docket number TY2006-001, filed on ______, Ser. No. ______, which is herein incorporated by reference in its entirety.

### BACKGROUND OF THE INVENTION

1. Field of the Invention

This invention relates to a system and a method for collecting and retrieving video and business transactions. The business operations range from a single branch to a large chain of stores or branches.

More particularly this invention relates to the web-based back-office server processing of video of point of sale (POS) business transactions to assist in the management and security of businesses.

2. Description of Related Art

Current practice includes large, expensive digital video recording systems at each point of sale terminal. It includes special software to be installed on point of sale client (POS) computers. Most current surveillance systems only provide current/real-time views without the ability to retrieve previous video. Systems that do record are expensive and hard to manage. They need to maintain a library of tapes or CD. Typically, video based archival is a resource intensive operation due to the size of video files. Current systems provide text on video, which is not indexed for retrieval based on a specific POS transaction. The disadvantages of current practice are that large, expensive networks are required. The problem to be solved is the desire for a video system that is low cost, easily retrievable transaction videos for store security including motion detection and salesperson integrity.

U.S. Pat. No. 6,504,481 B2 (Teller) describes a system, method, and device for monitoring the dispensing of liquids, in particular, beverages dispensed at a bar or restaurant. The system includes an electronic sensor device, data receiver, personal computer, bottle opener/camera system, bar code scanner, point of sale, bar camera, network, Web server, and paging system. The method automatically detects and monitors dispensing events, including detecting the type and amount of liquid, reconciling dispensing events with register ring-ups, recording information, saving video specific to the dispensing event, and sending a page indicating anomalies.

U.S. Pat. No. 6,847,393 B2 (Ashe et al.) describes a method and system for monitoring point of sale exceptions including the ability to automatically analyze POS transactional data for certain patterns or occurrences that typically indicate specific behavior at or near a POS terminal in connection with a sales related operation.

U.S. Pat. No. 6,726,094 B1 (Rantze et al.) discloses a customer self-service terminal for use in conducting retail transactions. The terminal includes a camera having multi-mode image capability. The camera is used to scan barcodes, check signing, credit card transactions, cash tendering, and general store video capture.

U.S. Pat. No. 6,343,739 B1 (Lippert) describes a method of providing security to operation of a self-service checkout terminal having a video camera and a printing device associated with the camera. The method captures video of the customer and determines if the customer has paid properly.

U.S. Pat. No. 5,895,453 (Cook) discloses a method and system for the detection of suspect sales transactions in a sales environment having point of sale devices and sales locations. The method and system further involve the use of surveillance cameras in which the output of the camera is keyed to the particular transactions of interest.

### BRIEF SUMMARY OF THE INVENTION

It is the objective of this invention to provide a system and a method for collecting and retrieving video and business transactions. The business operations range from a single branch to a large chain of stores or branches.

It is further an object of this invention to process video of point of sale (POS) business transactions to assist in the management and security of businesses.

The objects of this invention are achieved by a point of sale video server processing system, comprised of one or more point of sale (POS) terminals, one or more cameras, and one or more web servers. The POS terminals and web servers communicate via internet protocols. The POS terminals are implemented with point of sale personal computer hardware and software using one or more relational databases. The video captured by said cameras is processed and organized by video software residing on the point of sale personal computer hardware, video clips are captured and sent to the web server for retrieval. The web server is implemented with web server hardware and software, using one or more relational databases.

### BRIEF DESCRIPTION OF THE DRAWINGS

FIG. 1 shows a block diagram of the elements of this invention.

FIG. 2 gives a data structure for correlating transaction data and transaction videos.

FIG. 3 illustrates a point of sale system PC terminal with software to support a POS transaction system and the video catcher system of this invention.

FIG. 4 is a more detailed diagram of a main embodiment of this invention.

### DETAILED DESCRIPTION OF THE INVENTION

FIG. 1 shows a high level diagram of this invention. The dotted line 10 delineates the in store and out of store elements. The camera 11 is usually placed at or near each point of sale (POS) terminal. POS terminals would typically be implemented by standard personal computers such as PC 13 in FIG. 1. The camera can capture each customer transaction as well as be active at all times. The camera interfaces with camera software 12 which is resident in a personal computer, PC, 13. The camera connects to the PC via universal interfaces. The camera software has inherent video compression. The PC is connected to the internet via a broadband connection such as DSL. The video captured by the camera 11 and indexed by the camera software in the PC is stored in real-time at the server 15 outside of the store. The PC 13 in FIG. 1 also can perform the POS transactions. The PC software 12 would correlate POS transaction data and the video capture data from the camera 11.

Each POS normally operates with a hardware/software connection 14 to the Internet or Web. However, if the web goes down, the POS terminal continues to operate. There is a loose coupling of the POS to the back office (BO) server 15. The POS to BO connection is not required for the basic business functions of the POS. All transaction data is stored in a relational database on the hard drive in the POS.

A relational database stores all of its data inside tables. All operations on data are done on the tables themselves. Some operation produce other tables as the result. A table is a set of rows and columns. Each row is a set of columns with only one value for each. All rows from the same table have the same set of columns, although some columns may have NULL values. A NULL value is an “unknown” value. The rows from a relational table are analogous to a record, and the columns are analogous to a field. Below is an example of a relational table.

| NAME | COMPANY | E_MAIL |
|---|---|---|
| Jane A. Doe | ABC | jad@abc.com |
| Bill X. Smith | XYZ | bxs@xyz.com |

There are two basic operations one can perform on a relational table. The first one is retrieving a subset of its columns. The second is retrieving a subset of its rows. The field names such as company describe the content of the columns of the relational table. The rows delineate the individual records stored in the relational tables.

As transactions are created at a POS a log entry for the newest transaction is also created, this log entry is used to flag if the transaction has been uploaded to the web server. Part of the POS application, a transaction engine, is continuously running in the background. This component reads the log of transactions. If a transaction needs to be sent, it tries to send it. If the send fails (for example, if the connection to, or the Internet itself, is down), it goes to sleep and tries again later. The POS terminals communicate via HTTP protocol (hypertext transfer protocol) 14 with Back-office BO software, which is implemented on web servers 15, which can be located anywhere in the world. In addition, the BO software and data can be viewed from any store employee at any PC who has Internet access and a password.

A typical data structure for video storage at the server 15 is illustrated by the following example. The video is captured at the POS in five minute clips, indexed by the same clock as the POS application then sent to the BO for archival and later retrieval. Since the video indexing is synchronized at the POS and those same POS transactions are available at the server through the standard BO functionality specific retrieval of video correlated to any POS event is possible.

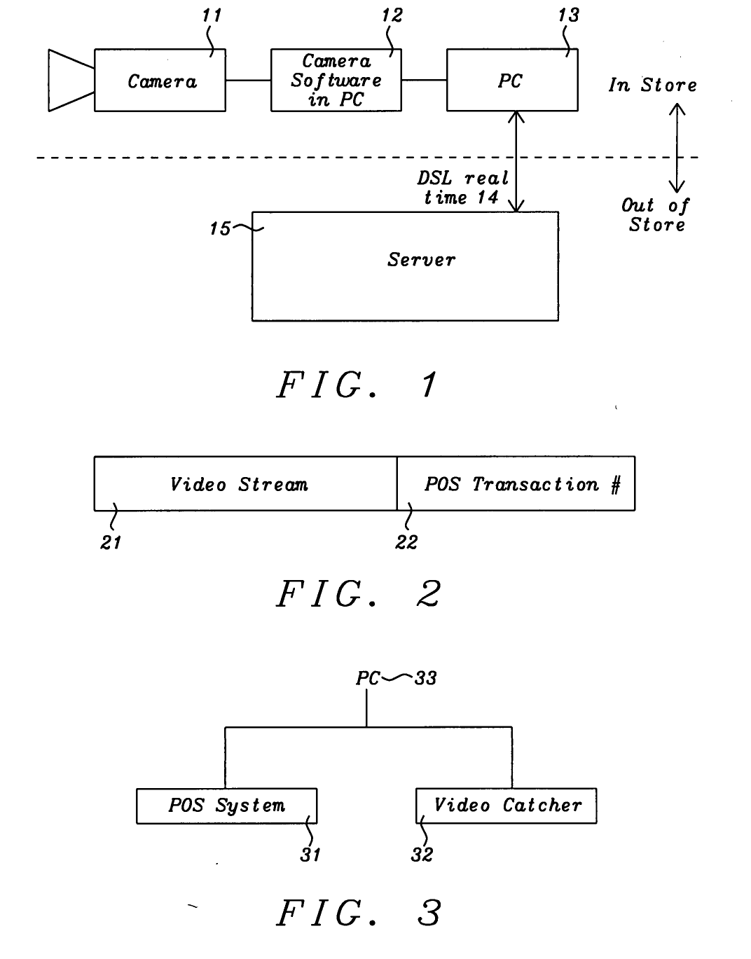

FIG. 2 shows a data structure where the video stream 21 captured by the camera. In addition, FIG. 2 shows the corresponding POS transaction data 22. Both the video 21 and the transaction 22 are captured at the point of sale terminal in the store. They both are indexed by the same POS clock. Then, both the video 21 and the transaction data 22 are sent to the back office at the server outside of the store for archiving and later retrieval.

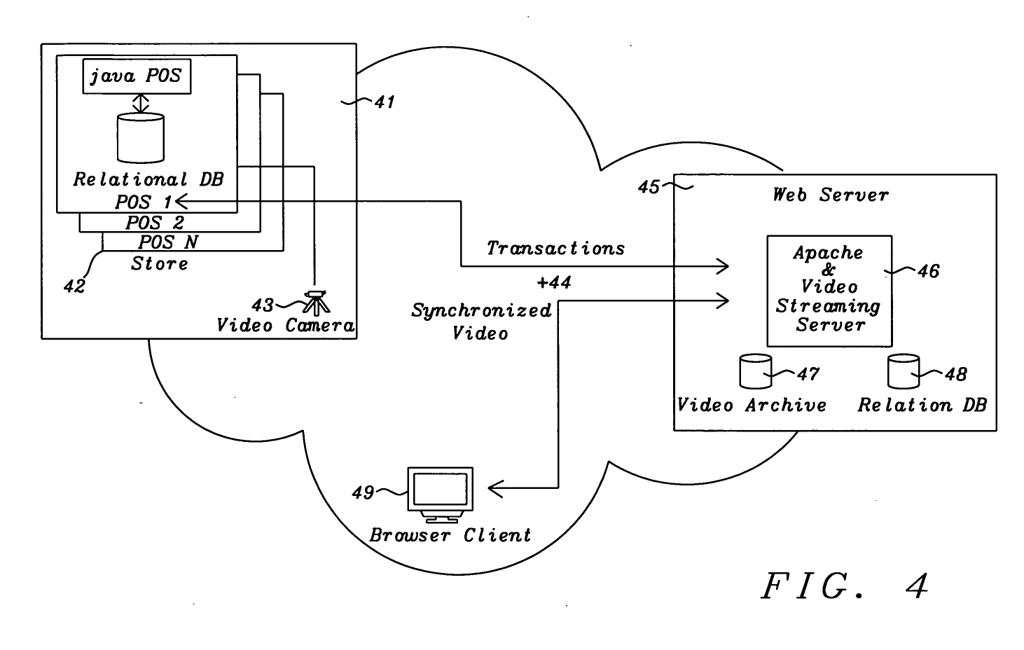

FIG. 3 shows how both the POS system 31 and the video catcher or capture system 32 co-exist in each POS PC 33 terminal in the stores or business branches. A given store or business branch could have several PC POS terminals, each of which would have the system elements shown in FIG. 3.

As transactions are created at a POS 31, a log entry for the newest transaction is also created, this log entry is used to flag if the transaction and its corresponding video has been uploaded to the web server. Part of the POS application 31, the BO interface, is continuously running in the background. This component reads the log of transactions. If a transaction and its corresponding video needs to be sent, it tries to send it. If the send fails (for example, if the connection to, or the Internet itself, is down), it goes to sleep and tries again later. Additionally, the BO interface requests update from the BO such as new items, price changes employees, etc.

FIG. 4 is a more detailed diagram of the main embodiment of this invention. Store 41 has several POS PC terminals 42 implemented with Java software using relational databases. The video cameras 43 are also shown. Typically, there would be one camera per POS terminal. The POS transaction plus the synchronized video 44 are sent to the web server 45 via a broadband connection such as DSL. The web server consists of a back-office transaction server plus a video streaming server 46. The web server 45 also includes a video archive data storage 47 and a relational database 48. Remote and local client web browsers 49 illustrate a method for store managers, corporate administrators, or system administrators to access and view a company's and its store's instantaneous performance along with individual POS terminal transactions and videos.

The web server 46 illustrates a back-office server implemented with Apache PHP using relational databases. PHP (recursive acronym for “PHP: Hypertext Preprocessor”) is a widely-used Open Source general-purpose scripting language that is especially suited for Web development and can be embedded into HTML (hypertext markup language). Apache PHP is one offering of the PHP language. PHP code is different from a script written in other languages like Perl or C. Instead of writing a program with lots of commands to output HTML, one can write an HTML script with some embedded code to do something (ie. to output some text). The PHP code is enclosed in special start and stop tags that allow you to jump into and out of “PHP mode”. What distinguishes PHP from something like client-side JavaScript is that the code is executed on the server. If you were to have HTML script with PHP code imbedded in it, the client would receive the results of running that script, with no way of determining what the underlying code may be. You can even configure your web server to process all your HTML files with PHP. The advantages of using PHP are that it is extremely simple for a newcomer, but offers many advanced features for a professional programmer. A programmer can jump in and in a short time start writing simple scripts. Remote and local web browsers 33 illustrate a method used by store managers, corporate administrators, or system administers to access and view a company & its store's instantaneous performance from minute to minute. The POS, BO, and Web Browsers all communicate via the Web 44.

The key advantages of this point of sale video server processing system. This system and method offers a low cost web archiving of video which is indexed and retrievable with its corresponding POS event/transaction data. Most current surveillance systems only provide current/real-time views without the ability to retrieve previous video. Systems that do record are expensive and hard to manage. Additionally, since this system stores the video on the web server management of the video by the client is vastly simplified, they no longer need to maintain a library of tapes or CD and all video is played back through a browser based web interface so no special application is required.

Typically video based archival is a resource intensive operation due to the size of video files, this application is further enabled through the use of the H264/AVC codec which provides up to 50% better compression than other video formats currently in use.

The web and PC architecture both offer full-scalability which results in improved performance and lower cost. There is a lower cost associated with projects developed with the technology of this invention due to the flexibility of easy design changes and well-understood software. There is less training required for programmers and system testers. Projects can draw on the huge talent pool in the open source development community. The invention allows configurable modules for different types of businesses and sales promotions. The invention allows remote monitoring of the POS terminals, the video software and back-office systems from anywhere via the web. There is minimal time required for installation of the POS terminals and the video software, since the POS terminal setup is as basic as a home PC setup. Another advantage is that the back-office web servers and video streaming servers can be provided as a service or deployed within a corporation. For example, Software as a Service (SAAS) is a software distribution model in which applications are hosted by a vendor or service provider and made available to customers over a network, typically the Internet. Another advantage of this invention is that the back-office system and the video streaming system is maintained in customer centric databases, making it impossible for customers to see other's data. Each store client (individual POS, store or multi-store owner) which includes a store's individual video capture system gets their own instance of a database. When they log into the back-office and video streaming servers, they are attached to their own relational database associated and validated via their user login and password. This method provides easily retrievable transaction videos and data for store security including motion detection and salesperson integrity.

While this invention has been particularly shown and described with Reference to the preferred embodiments thereof, it will be understood by those Skilled in the art that various changes in form and details may be made without Departing from the spirit and scope of this invention.

What is claimed is:

1. A point of sale video server processing system, comprising:
one or more point of sale (POS) terminals,
one or more cameras, and
one or more web servers,
wherein said POS terminals and said web servers communicate via internet protocols,
wherein said POS terminals are implemented with point of sale personal computer hardware and software using one or more relational databases,
wherein video captured by said cameras is processed and organized by video software residing on said point of sale personal computer hardware,
wherein said web server is implemented with web server hardware and software, using one or more relational databases.

2. The point of sale video server processing system of claim 1, wherein said POS terminals, said video software, and said web servers are implemented with executable, configurable software modules, wherein said modules can be changed to implement different functions for different businesses.

3. The point of sale video server processing system of claim 1, wherein said POS terminals and said video software can operate standalone without communicating with said web server.

4. The point of sale video server processing system of claim 1, wherein said POS terminals, said video software, and said web-based back-office servers are scalable allowing the addition of POS terminals and business locations without degrading system performance.

5. The point of sale video server processing system of claim 1, wherein a real-time status of said POS terminals, said video software, and said back-office web servers is obtained at remote locations via personal computers with web access, wherein said status includes ability to review captured video, which may or may not be correlated to customer transactions.

6. A web-based back-office system comprising:
one or more web servers, and
one or more video streaming servers,
wherein said web servers and said video streaming servers are implemented with web server hardware and software and video streaming hardware and software, using one or more relational databases,
wherein said web servers and said video streaming servers have communication with point of sale (POS) terminals and with video software via internet protocols,
wherein said communication includes movement of POS transactions and synchronized video to said web servers and to said video streaming servers respectively.

7. The web-based back-office system of claim 6, wherein said web servers and said video streaming servers are implemented with executable, configurable software modules, wherein said modules can be changed to implement different functions for different businesses.

8. The web-based back-office system of claim 6, wherein said web servers and said video streaming servers allow said POS terminals and said video software to operate standalone without communicating with said web servers and said video streaming servers.

9. The web-based back-office system of claim 6, wherein said web-based back office is scalable allowing the addition of POS terminals, cameras, and business locations without degrading system performance.

10. The web-based back-office system of claim 6, wherein a real-time status of said POS terminals, said video software, and said back-office system is obtained at remote locations via personal computers with web access, wherein said status includes ability to review captured video, which may or may not be correlated to customer transactions.

11. A point of sale POS system comprising,
one or more point of sale (POS) terminals, and
one or more cameras,
wherein said POS terminals can communicate with web servers via internet protocols,
wherein said POS are implemented with point of sale personal computer hardware and software, using one or more relational databases,
wherein video captured by said cameras is processed and organized by video software residing on said point of sale personal computer hardware.

12. The point of sale system of claim 11, wherein said POS terminals and said video software are implemented with executable, configurable software modules, wherein said modules can be changed to implement different functions for different businesses.

13. The point of sale system of claim 11, wherein said POS terminals and said video software can operate standalone without communicating with said web servers.

14. The point of sale system of claim 11, wherein said POS terminals and said video software are scalable allowing the addition of POS terminals and business locations without degrading system performance.

15. The point of sale system of claim 11, wherein a real-time status of said POS terminals, said video software, and said back-office web servers is obtained at remote locations via personal computers with web access, wherein said status includes ability to review captured video, which may or may not be correlated to customer transactions.

16. A method of providing a point of sale video server processing system, comprising the steps of:
providing one or more point of sale (POS) terminals,
providing one or more cameras, and
providing one or more web servers,
wherein said POS terminals and said web servers communicate via internet protocols,
wherein said POS terminals are implemented with point of sale personal computer hardware and software using one or more relational databases,
wherein video captured by said cameras is processed and organized by video software residing on said point of sale personal computer hardware,
wherein said web server is implemented with web server hardware and software, using one or more relational databases.

17. The method of providing a point of sale video server processing system of claim 16, wherein said POS terminals, said video software, and said web servers are implemented with executable, configurable software modules, wherein said modules can be changed to implement different functions for different businesses.

18. The method of providing a point of sale video server processing system of claim 16, wherein said POS terminals and said video software can operate standalone without communicating with said web server.

19. The method of providing a point of sale video server processing system of claim 16, wherein said POS terminals, said video software, and said web-based back-office servers are scalable allowing the addition of POS terminals and business locations without degrading system performance.

20. The method of providing a point of sale video server processing system of claim 16, wherein a real-time status of said POS terminals, said video software, and said back-office web servers is obtained at remote locations via personal computers with web access, wherein said status includes ability to review captured video, which may or may not be correlated to customer transactions.

21. A method of providing a web-based back-office system comprising the steps of:
providing one or more web servers, and
providing one or more video streaming servers,
wherein said web servers and said video streaming servers are implemented with web server hardware and software and video streaming hardware and software, using one or more relational databases,
wherein said web servers and said video streaming servers have communication with point of sale (POS) terminals and with video software via internet protocols,
wherein said communication includes movement of POS transactions and synchronized video to said web servers and to said video streaming servers respectively.

22. The method of providing a web-based back-office system of claim 21, wherein said web servers and said video streaming servers are implemented with executable, configurable software modules, wherein said modules can be changed to implement different functions for different businesses.

23. The method of providing a web-based back-office system of claim 21,
wherein
said web servers and said video streaming servers allow said POS terminals and said video software to operate standalone without communicating with said web servers and said video streaming servers.

24. The method of providing a web-based back-office system of claim 21, wherein said web-based back office is scalable allowing the addition of POS terminals, cameras, and business locations without degrading system performance.

25. The method of providing a web-based back-office system of claim 21, wherein a real-time status of said POS terminals, said video software, and said back-office system is obtained at remote locations via personal computers with web access, wherein said status includes ability to review captured video, which may or may not be correlated to customer transactions.

26. A method of providing a point of sale POS system comprising the steps of:
providing one or more point of sale (POS) terminals, and
providing one or more cameras,
wherein said POS terminals can communicate with web servers via internet protocols,
wherein said POS are implemented with point of sale personal computer hardware and software, using one or more relational databases,
wherein video captured by said cameras is processed and organized by video software residing on said point of sale personal computer hardware.

27. The method of providing a point of sale POS system of claim 26, wherein said POS terminals and said video software are implemented with executable, configurable software modules, wherein said modules can be changed to implement different functions for different businesses.

28. The method of providing a point of sale POS system of claim 26, wherein said POS terminals and said video software can operate standalone without communicating with said web servers.

29. The method of providing a point of sale POS system of claim 26, wherein said POS terminals and said video software are scalable allowing the addition of POS terminals and business locations without degrading system performance.

30. The method of providing a point of sale POS system of claim 26, wherein a real-time status of said POS terminals, said video software, and said back-office web servers is obtained at remote locations via personal computers with web access, wherein said status includes ability to review captured video, which may, or may not be correlated to customer transactions.
